(19) United States
(12) Patent Application Publication
(10) Pub. No.: US 2024/0366455 A1
(43) Pub. Date: Nov. 7, 2024

(54) SURGICAL OPERATION UNIT WITH LOCAL OPERATION FIELD

(71) Applicant: Surgicube IP B.V., Vierpolders (NL)

(72) Inventor: Gerrit Jan Vijfvinkel, Vierpolders (NL)

(73) Assignee: Surgicube IP B.V., Vierpolders (NL)

(21) Appl. No.: 18/576,389

(22) PCT Filed: Jul. 6, 2022
(86) PCT No.: PCT/NL2022/050386

§ 371 Date: Jan. 4, 2024

(30) Foreign Application Priority Data
Jul. 8, 2021 (NL) 2028657

(51) Int. Cl. A61G 13/10

(52) U.S. Cl. CPC A61G 13/108

(57) ABSTRACT

Surgical operation unit with a front side (2) and an air flow unit (40). A filter unit (60a, 60b) is present for filtering air entering the air flow unit (40) during operation, and the front side (2) has at least one opening (16) and a cover (22), covering at least part of the opening (16). The air flow unit (40) has at least one air outlet opening (48) for directing an air flow (F) from the air flow unit (40) over the cover (22) into a clean air area (O; I). An air flow parameter sensor (11; 12) is positioned downstream from the at least one air outlet opening (48), and a control unit (15) is connected to the air flow parameter sensor (11; 12) and arranged to process a sensor signal received from the air flow parameter sensor (11; 12).

### FIELD OF THE INVENTION

The present invention relates to a surgical operation unit, comprising a front side and an air flow unit, the air flow unit being provided with a filter unit for filtering air entering the air flow unit during operation, the front side being provided with at least one opening and a cover, covering at least part of the opening, the air flow unit comprising at least one air outlet opening for directing an air flow from the air flow unit over the cover into a clean air area.

### BACKGROUND ART

European patent publication EP-A-1 462 076 discloses an operation unit, comprising a wall/front side and an air flow unit. The air flow unit is provided with means for filtering the air, and the wall is provided with at least one opening and a cover, covering at least part of said opening. The air flow unit comprises at least one air outlet opening for directing air from said air flow unit over said cover. Air inlet means may be provided for retracting air to said air flow unit.

### SUMMARY OF THE INVENTION

The present invention seeks to provide an improved surgical operation unit, allowing more efficient use of the unit and an improved control of the air flow and air quality in the operating area.

According to the present invention, a surgical operation unit as defined above is provided, in which a particle detection sensor is positioned downstream from the at least one air outlet opening, and a control unit is connected to the particle detection sensor and arranged to process a sensor signal received from the particle detection sensor. The present invention monitors the quality of the air that is blown onto the clean air area, and warrants that a continuously controlled stream of high-quality clean air is flowing onto the operating area.

In an embodiment, the operation unit comprises an air flow velocity sensor. The control unit receives air flow velocity values and determines if a correct and steady air flow is directed onto the clean air area and monitors a proper functioning of the components of the surgical operation unit. The relatively close proximity of the particle detection sensor and of the airflow sensor to the clean air area in the surgical operation unit, which is of relatively compact dimensions, results in accurate measurement of the air flow and of the cleanliness of the air in the operating area.

### SHORT DESCRIPTION OF DRAWINGS

The present invention will be discussed in more detail below, with reference to the attached drawings, in which

FIG. 1 shows a perspective view of a surgical operation unit according to an embodiment of the present invention;

FIG. 2 shows a divided cross-sectional view of the surgical operation unit shown in FIG. 1.

FIG. 3A shows a cross sectional perspective view of a surgical operation unit according to a further embodiment of the present invention during actual use;

FIG. 3B shows a perspective view of a first side of the surgical operation unit shown in FIG. 3A;

FIG. 3C shows a perspective view of an operational side of the surgical operation unit shown in FIG. 3A;

FIG. 3D shows a detailed view of a clean air area of the surgical operation unit shown in FIG. 3A;

FIG. 4 shows a cross sectional view illustrating functional units of the surgical operation unit according to a further embodiment of the present invention;

FIG. 5 shows a block diagram of a control unit and associated elements according to an even further embodiment of the present invention; and

FIG. 6 shows a top view of an embodiment of a cover as used in the present invention embodiments.

### DESCRIPTION OF EMBODIMENTS

The present invention embodiments relate to improvements to the operation unit embodiments described in European patent publication EP-A-1 462 076, which is incorporated herein in its entirety by reference.

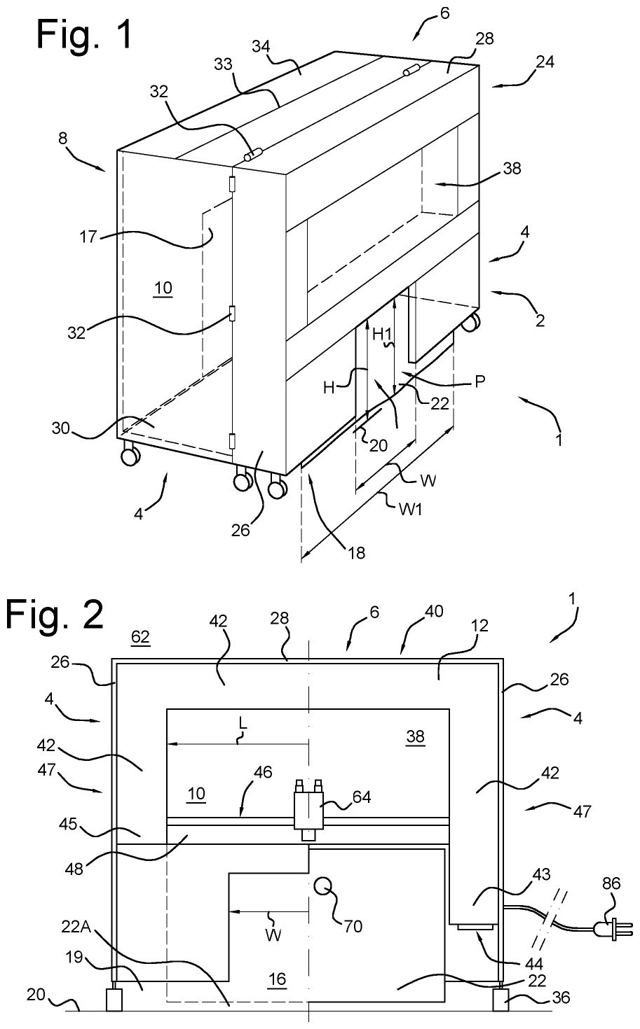

In FIGS. 1 and 2 an exemplary embodiment of a surgical operation unit 1 are shown in perspective view, and in a cross-sectional view, respectively.

The surgical operation unit comprises a front side 2, two opposite sidewalls 4, connected to the front side 2 and a top wall or roof 6 connected to the front side 2 and the sidewalls 4. A back wall 8 is provided, connected to the sidewalls 4 and the roof 6. The front side 2, sidewalls 4, roof 6 and back wall 8 enclose an inner space 10 within the operation unit 1, sufficiently large for housing at least some operation equipment, an airflow unit 40 to be discussed hereafter and at least one person performing surgery, such as an eye surgeon, orthopedic surgeon or another type of medical specialist. An operation unit 1 according to the present invention can for example be between 2 and 2.5 m high, between 2 and 3 m wide and between 1.5 and 2.5 m deep. These sizes are only given by way of example and are by no means limiting the scope of the present invention.

In the embodiment of the operation unit 1 according to FIG. 1, the front side comprises an opening 16 extending from a lower side 18 of the front side 2. For example, a hospital bed, stretcher or the like can be driven with a head or foot part thereof into the opening 16 in the direction P. The opening 16 has a height H of for example between 60 cm and 100-120 cm, measured from the ground 20, and has a width W of for example between 60 cm and 1 m. These sizes are also only given by way of example and should by no means be considered as limiting the invention. A cover 22 is suspended from a hanging component such as a series of hooks, a clamping rail, rings or the like, hanging down from above the opening 16 and extending across the opening 16 to close to the ground 20 or even on the ground 20. The width W1 of the cover 22 is larger than the width W of the opening 16, whereas the height H1 of the cover 22 is preferably larger than the height H of the opening 16. When the operation unit 1 is not in use, or at least when a patient is not introduced through the opening 16, as will be explained hereafter, the cover 22 hangs down behind the opening 16, in the inner space 10, closing the opening 16 substantially.

The cover 22 is preferably made of cloth or plastic, such as a surgery blanket and is sufficiently pliable, foldable or the like to be used for covering at least part of a patient to be operated on, as will be discussed hereafter.

The operation unit 1 according to FIG. 1 comprises a front part 24 which is substantially rigid and comprises the front side 2, two side panels 26 and a top panel 28. A second side panel 30 is connected to each first side panel 26 by hinges 32 or the like, whereas a roof panel 34 is connected to the top panel 28 by further hinges 32. The roof panel 34 may be foldable in two parts across a folding line 33 for compactness. The operation unit 1 is in a folded position relatively small and can for example be maneuvered through a door opening into and out of various rooms. To this end the operation unit 1 is preferably mounted on wheels 36.

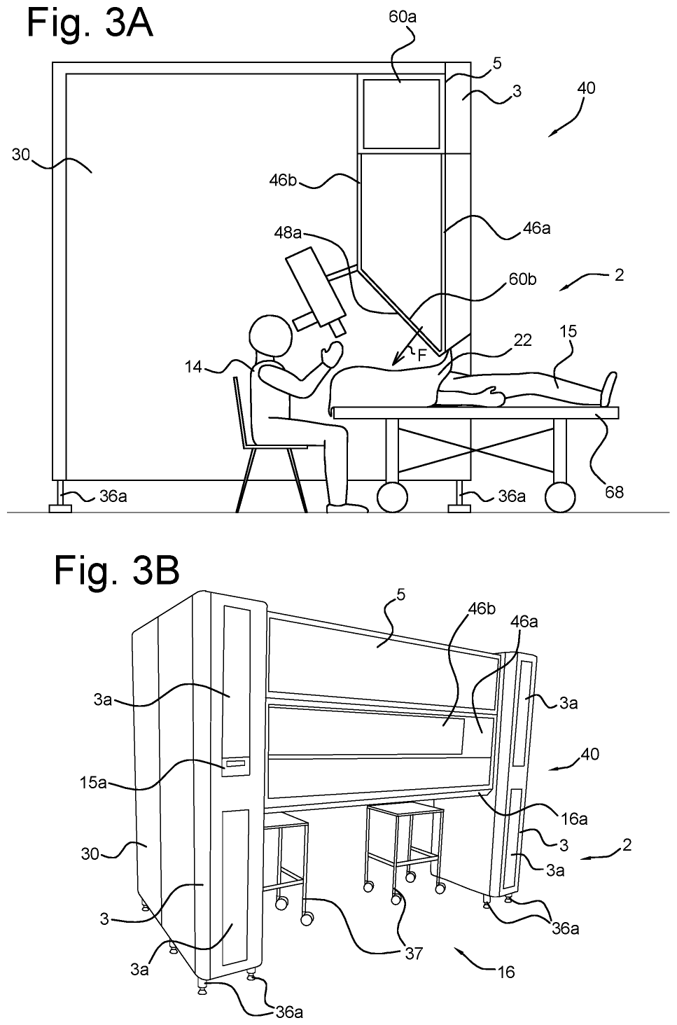

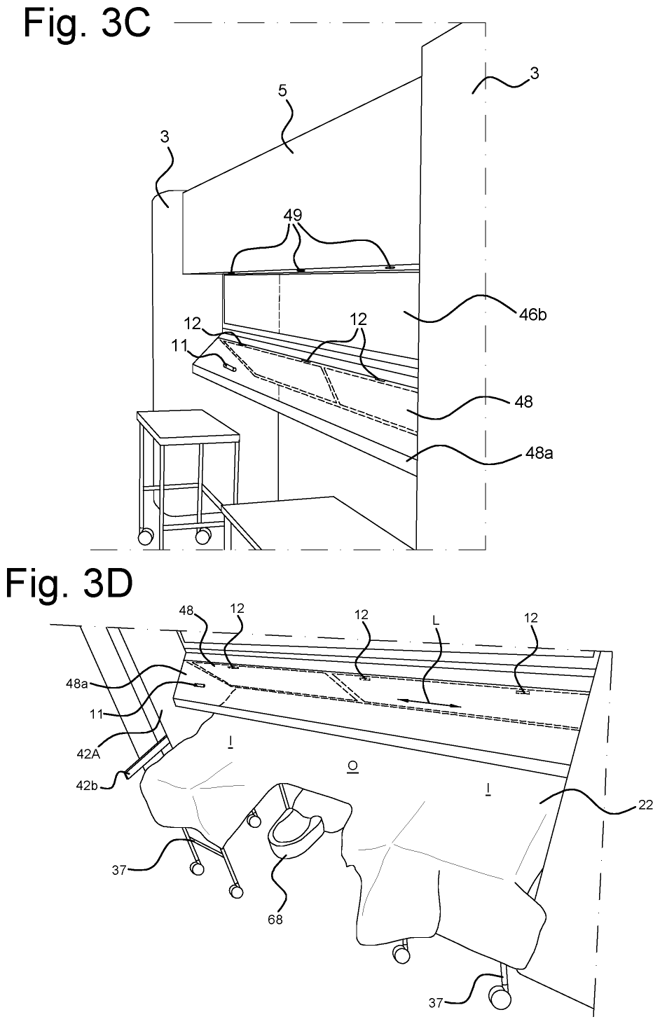

As can be seen in for example FIG. 1, the front side 2 is provided with a transparent part 38 above the opening 16, for example a window. As is shown in for example FIG. 3A a person 14 within the space 10 can have visual contact through the panel 38 with a person positioned outside the space 10, for example a nurse, an anesthetist, the patient 15 or other people. The person 14 can also have visual contact with apparatuses in the area around the operation unit 1. The second side panels 30 are preferably made also of transparent material, such as glass or plastic.

In order to facilitate foldability of the operation unit 1, the back wall 8 is preferably foldable and can for example be provided with a door 17 allowing entrance into the inner space 10. In an advantageous embodiment however the back wall 8 is made of for example plastic strips extending from the roof 34, overlapping each other partly, such that the wall 8 can easily be traversed by a person, whereas the back wall 8 provides for a closed back wall during use. The back wall may have an opening over its full height of 10-50 cm in width, to allow the air to leave the operation unit 1 without causing turbulence.

Within the space 10 within the operation unit 1 an airflow unit 40 is provided comprising a duct 42 extending along parts of the two opposite sidewalls 4, behind the side panels 26 and across the front side, below said top panel 28. The duct 42 is at one end 43 provided with an inlet opening 44 for air from within said space 10, whereas at an opposite end 45 the duct 42 is connected to an air outlet unit 46 extending across the width of the air unit 1 between the two legs 47 of the substantially U-shaped duct 42, under said transparent part 38 and across the opening 16. The length L of said air outlet unit 46 is larger than the width W of said opening 16 and corresponds preferably substantially to the width W1 of said cover 22, of which in FIG. 2 only the right side is shown. Left to the center line C said cover 22 is only shown by its contour 22A, showing the opening 16.

The air outlet unit 46 comprises an air outlet opening 48 extending over approximately the full length L of said air outlet unit 46. The air outlet opening 48 may also be provided as a series of smaller openings one beside the other. The air outlet opening 48 is preferably configured such that during use an airflow is provided for leaving said air outlet opening 48 in a direction downward, away from said front side 2, into a clean air area as is shown schematically by the arrows F in the figures.

A further embodiment of the operation unit 1 as shown in the perspective view of FIG. 3B, has an alternative structure comprising two columns 3 and a connecting box 5. Below the connecting box 5 the air outlet unit 46 is provided, with a front wall 46a and a back wall 46b indicated in FIG. 3B. A rim 16a at the top of the opening 16 allows to mount the cover 22. The two columns 3 are e.g. provided with adjustable stands 36a, as alternative to the wheels 36 of the FIGS. 1 and 2 embodiments, to allow height adjustment of the operation unit 1. One or both columns 3 are provided with inlet screens 3a allowing air to enter to the airflow unit 40. In this embodiment, the opening 16 is provided as the space between columns 3 and below the air outlet unit 46, providing space for both a patent bed 68 and e.g., two wheeled tables 37 (e.g. for instruments etc.). In this exemplary view, an optional indicator unit 15a is provided in the left column 3 (see description of control unit further below). As an alternative arrangement, the indicator unit 15a may be provided as an external unit, it is noted that the columns 3 and connecting box 5 can be manufactured with dimensions as needed in accordance with specific user requirements, and/or can be provided in a range of standardized dimensions.

For actual use, the surgical operation unit 1 is brought to an operation site which may for example be in a clean room, an operation theatre, a sick room, a recovery room or any other room allowing sufficient space for setting up such surgical operation unit 1. In specific circumstances the surgical operation unit 1 could even be used outside buildings, for example on a military field, or on a disaster site. The unit is then set up in the position as shown in FIG. 3A. A patient 15 is prepared for operation, for example by suitable anaesthetics or the like and placed on for example an operation table 68, a stretcher or the like, suitably supporting the patient. The patient 15 and any person in the surroundings 62 may wear plane clothes and does not have to perform specific washing operations or the like.

As described above, FIG. 3A provides a schematic view of an operation on a head of a patient 15, for example an eye operation. To this end the head end of the operation bed 68 is pushed into the direction P through the opening 16, under the cover 22, such that the cover 22 rests on said head covering said head of the patient 15 and hanging down to near the floor 20.

As is schematically shown in FIG. 2, an operation opening 70 is made in the cover 22, such that the operation site, such as an eye is accessible for the surgeon 14 through the cover 22, as is common in commonly known operation techniques. As an alternative, the cover 22 is provided with an operation area opening 22B, as shown in FIGS. 3D and 6 (discussed in further detail below), and a separate operation cover is provided suitable for the specific surgical operation to be executed.

The airflow unit 40 is brought into operation, such that the airflow F is directed downward over the cover 22, into the direction of the surgeon 14, who may for example be sitting within said space 10 on a chair, having his knees against the cover 22, under the head end of the operation table 68. Due to the airflow F over the cover 22 the operation site is kept sterile, thereby preventing infection. The air is e.g., recirculated through the airflow unit 40, maintaining sufficient sterility within said space 10. Due to the transparency of at least part of the operation unit 1, the surgeon 14 can keep visual contact with other persons and the patient 15.

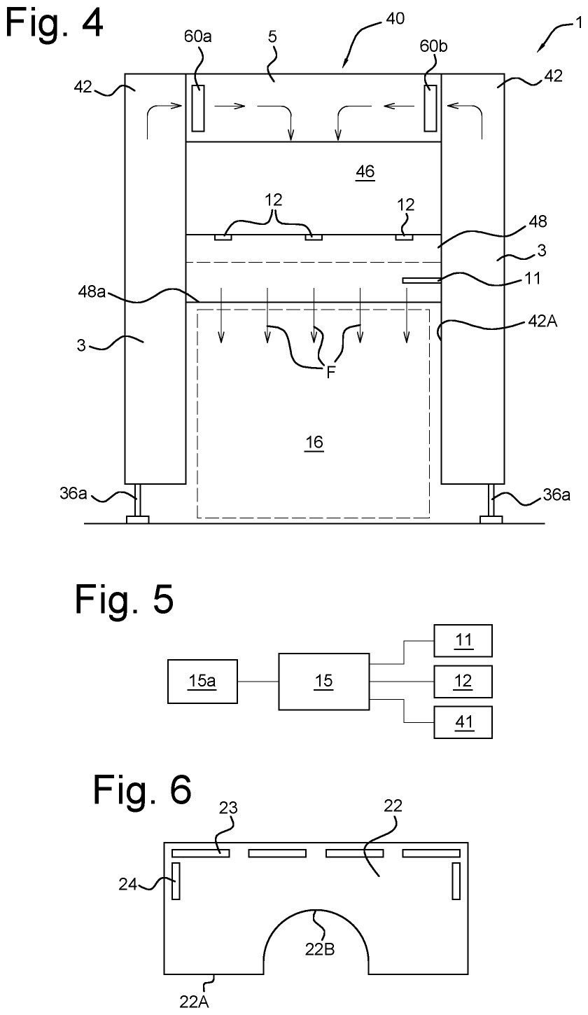

In the perspective view of FIG. 3A and in FIG. 4, which show schematic cross-sectional view of exemplary embodiments of the surgical operation unit 1, the airflow within the operation unit 1 is schematically shown during use. This can be understood as follows. Within the airflow unit 40 pumping means are positioned for generating an airflow (e.g., inside one/both columns 3, or inside connecting box 5 in the FIG. 3A-D embodiment). Furthermore, filtering means 60a, 60b are positioned in the air flow for filtering the air. The filtering means 60a, 60b are designed such that air in the direction of the arrows is filtered such that sterile air leaves the air outlet opening 48 in the direction F during use. Sterile air has to be understood in this description as at least encompassing air sufficiently clean to be allowed in operation environments as discussed. To this end the pre-filtering means (e.g. the initial filtering means 60a as indicated in FIGS. 3A and 4) can for example comprise a G3 or G4 filter, according to EN779, in combination with a pre filter means of type F7 to F9, according to EN779, upstream from said pumping means for filtering particles from the air, whereas a second filtering means 60b of the type H14 according to EN1822 can be provided downstream from said pumping means for further sterilization of said air (see FIG. 3A).

During use air is sucked in through the inlet screens 3a and through said filtering means 60a, 60b into the direction of the air outlet unit 46. The air is then forced in the direction F downward and preferably away from the front side 2 over the cover 22. As is clear from the drawings, the lower edge 18 of the operation unit 1 can be positioned during use a little above the ground 20, leaving an opening just above the ground 20. This substantially prevents undesired pressure differences between the inner space 10 of the unit 1 and the surrounding environment. Therefore, turbulence 20 of air is substantially prevented.

FIG. 3C and FIG. 3D show perspective views of an operational side of the operation unit 1 according to an embodiment of the present invention. The columns 3 and connection box 5 are visible through side wall 30, as is the back wall 46b, outlet opening 48 and air guide 48a of the air outlet unit 46. As shown in FIG. 3D, the cover 22 is draped over the tables 37 and the patient bed 68, thus guiding the clean air from the outlet opening 48 towards the end of the cover 22, providing clean, sterile air in the clean air area comprising a (central) operation area O and two instrument table areas I. The embodiment shown in these figures are provided with two types of air flow parameter sensors 11, 12 provided in the (clean) air flow F. Furthermore, in FIG. 3C, a light unit 49 arranged to illuminate the clean air area O; I is shown, in this embodiment comprising three separate light points.

FIG. 5 shows a schematic diagram of a control unit 15 as applied in the present invention embodiments. The present invention embodiments relate to a surgical operation unit, comprising a front side 2 and an air flow unit 40, the air flow unit 40 being provided with a filter unit 60a, 60b for filtering air entering the air flow unit 40 during operation, the front side 2 being provided with at least one opening 16 and a cover 22, covering at least part of the opening 16, the air flow unit 40 comprising at least one air outlet opening 48 for directing an air flow F from the air flow unit 40 over the cover 22 into a clean air area O; I. The surgical operation unit 1 further comprises an air flow parameter sensor 11; 12 positioned downstream from the at least one air outlet opening 48, and a control unit 15 connected to the air flow parameter sensor 11; 12 and arranged to process a sensor signal received from the air flow parameter sensor 11; 12. This allows e.g. to monitor correct and steady air flow and proper operation of the components of the surgical operation unit 1.

In a specific embodiment, the air flow parameter sensor 11; 12 is an air flow velocity sensor 11. This allows to provide a flow velocity signal to the control unit 15 and monitor whether or not the surgical operation unit 1 is operating within predetermined operational ranges of the air velocity. The control unit 15 can also be arranged to determine the dimensions of the clean air area O; I, e.g. from the farthest point of the air outlet opening 48, or to check whether a minimum dimension is obtained. Furthermore, the control unit 15 in a further embodiment is connected to the air flow unit 40 (or components thereof) to provide a (closed loop) control of the air flow unit 40, more specifically one or more air pumps/fans.

In order to obtain proper sensor signals, the air flow parameter sensor 11; 12 is positioned extending from an inner side wall 42A of the surgical operation unit 1 in a further embodiment. This allows to have a proper measurement of the air flow F parameters, e.g., velocity, in an undisturbed portion of the clean air area O; I, and without possible interference with the user or further user equipment, such as a microscope or surgical instruments.

In a further exemplary embodiment, the air flow parameter sensor 11; 12 is a particle detection sensor 12. Such a particle detection sensor 12, providing a particle detection signal to the control unit 15, allows to measure whether or not a certain class of clean air is actually obtained during operation. As indicated in the FIGS. 3C, 3D and 4 embodiments, three particle detection sensors 12 are provided, allowing to check air quality in the corresponding parts of the clean air area O; I. The particle detection sensors 12 are e.g. positioned along a top rim of the outlet opening 48, allowing a correct sensor field of view. Alternatively, one particle detection sensor 12 is provided, which can be positioned at a predetermined position, e.g. one of the three positions indicated in the embodiment shown in FIGS. 3C and 3D, or which can be repositioned or adjusted during actual use.

More generically, the particle detection sensor(s) 12 is (are) positioned adjustable along a direction L parallel to the front side 2 in a further embodiment. This provides an ability to re-position one or more sensors in order not to interfere with other equipment or the user of the surgical operation unit 1.

As most clearly seen in the perspective view of FIG. 3D, the surgical operation unit 1 comprises an operation area O adjacent to the cover 22 and in the clean air area O; I, in a further embodiment. The air flow parameter sensor 11; 12 may then also be positioned in an air flow F towards the operation area O to allow monitoring the air flow F in the specific, spatially more limited operation area O.

Additionally, the surgical operation unit 1 may comprise an instrument table area I adjacent to the operation area O and in the clean air area O; I, and the air flow parameter sensor 11; 12 is positioned in an air flow F towards the instrument table area I. As shown in FIG. 3B and FIG. 3D, two tables 37 are positioned in the opening 16 during actual use, and the cover 22 is arranged to be hanging over the two tables 37. In this manner, the clean air exiting the outlet opening 48 flows over the instruments, keeping a sterile environment in the instrument table area I in addition to the sterile environment in the operation area O.

As described above, the control unit 15 may be arranged to generate a warning signal in further embodiments if a detected sensor signal is outside an associated sensor threshold range. As shown in the block diagram of FIG. 5 and visible in the view of FIG. 3B, a display unit 15a may be provided to display actual sensor data, and/or warnings. The control unit 15 may be further arranged to provide proper optical and/or auditory warning signals if needed, e.g. on the display unit 15a with coloured indications, sensor values, etc.

In even further exemplary embodiments, a pressure sensor is connected to the control unit and arranged to measure a pressure difference over one or more of the filter units 60a; 60b present in the surgical operation unit 1. A too high a pressure difference may be an indication of a clogged or polluted filter unit 60a; 60b, and the control unit 15 may provide a warning signal indicating a needed filter unit change.

In order to assist in assessing whether a patient or bed 68 is positioned properly within the clean air area O; I, the surgical operation unit 1 may further comprise an indicator element 42b arranged to provide an indication of the operation area as a distance perpendicular to the front side 2. As shown in the exemplary embodiment in FIG. 3D, the indicator element 42b may be a mechanical stick, extending or extendable from a side wall of the column 3, or another structural part of the surgical operation unit 1. The end of the indicator element 42b can be easily aligned with the (moveable) table 37, allowing an easy check whether the set-up of the surgical operation unit 1 is within the standard dimensions. Alternatively, the indicator element 42b may be implemented as an optically operating element, attached to a frame of the surgical operation unit 1.

FIG. 6 shows a top view of an exemplary embodiment of a cover 22 as used in the present invention embodiments, and attached to the surgical operating unit 1 as e.g. shown in FIG. 3A and FIG. 3B. In an embodiment of the present invention, the cover 22 is a drape attached to an upper rim 16a of the at least one opening 16 in the front side 2 of the surgical operation unit 1. This allows to close off the clean air area O; I already before a patient/patient bed 68 is positioned in the opening 16 and allows easy maneuvering of the patient bed 68 to obtain a proper position in the surgical operation unit 1 with the cover laying over the patient/patient bed 68.

In a further embodiment, the cover 22 is attached to one or two side rims of the at least one opening 16 in the front side 2 of the surgical operation unit 1. This allows to possibly stretch and/or tension the cover 22 to obtain a proper closing off of the clean air area O; I.

As shown in the exemplary embodiment of FIG. 6, the cover 22 may be provided with a plurality of reinforced attachment edges 23; 24, and the front side 2 is provided with slots arranged to accommodate the plurality of reinforced attachment edges 23; 24. This may be a cost-effective implementation of the cover 22, e.g. by providing the reinforced attachment edges 23; 24 as cardboard material enveloped in cover material. The slots in the front side 2 are e.g. implemented as upward extending folded edges. Alternatively, the cover may be provided with self-adhesive edges, or other removable attachment elements such as Velcro patches.

1. A surgical operation unit comprising:
a front side and an air flow unit, the air flow unit being provided with a filter unit for filtering air entering the air flow unit during operation, the front side being provided with at least one opening and a cover, covering at least part of the opening, the air flow unit comprising at least one air outlet opening for directing an air flow from the air flow unit over the cover into a clean air area,
a particle detection sensor positioned downstream from the at least one air outlet opening, and
a control unit connected to the particle detection sensor and arranged to process a sensor signal received from the particle detection sensor.

2. The surgical operation unit according to embodiment claim 1, comprising an air flow velocity sensor.

3. The surgical operation unit according to claim 1, wherein one or both of the particle detection sensor and the air flow velocity sensor is/are positioned extending from an inner side wall of the surgical operation unit.

4. The surgical operation unit according to claim 3, wherein the particle detection sensor is positioned adjustable along a direction parallel to the front side.

5. The surgical operation unit according to claim 1, further comprising an operation area adjacent to the cover and in the clean air area, and wherein the particle detection sensor is positioned in an air flow towards the operation area.

6. The surgical operation unit according to claim 5, further comprising an instrument table area adjacent to the operation area and in the clean air area, and wherein the particle detection sensor is positioned in an air flow towards the instrument table area.

7. The surgical operation unit according to claim 5, further comprising a light unit arranged to illuminate the clean air area.

8. The surgical operation unit according to claim 1, wherein the control unit is configured to generate a warning signal if a detected sensor signal is outside an associated sensor threshold range.

9. The surgical operation unit according to claim 1, further comprising a pressure sensor connected to the control unit and configured to measure a pressure difference over the filter unit.

10. The surgical operation unit according to claim 1, further comprising an indicator element configured to provide an indication of the operation area as a distance perpendicular to the front side.

11. The surgical operation unit according to claim 1, wherein the cover is a drape attached to an upper rim of the at least one opening in the front side of the surgical operation unit.

12. The surgical operation unit according to claim 11, wherein the cover is attached to one or two side rims of the at least one opening in the front side of the surgical operation unit.

13. The surgical operation unit according to claim 11, wherein the cover is provided with a plurality of reinforced attachment edges, and the front side is provided with slots adapted to accommodate the plurality of reinforced attachment edges.

14. The surgical operation unit according to claim 11, wherein the cover is provided with an operation area opening.
